(19) United States
(12) Patent Application Publication
(10) Pub. No.: US 2009/0211430 A1
(43) Pub. Date: Aug. 27, 2009

(54) MULTIPLE-TIPPED DRUMMING TOOL

(76) Inventor: Harold J. Wilson, San Francisco, CA (US)

Correspondence Address: Weaver Austin Villeneuve & Sampson LLP, P.O. BOX 70250, OAKLAND, CA, 94612-0250, US

(21) Appl. No.: 12/034,828

(22) Filed: Feb. 21, 2008

(51) Int. Cl. G10D 13/02

(52) U.S. Cl. 84/422.4

(57) ABSTRACT

A multiple-tipped drumming tool has 2-4 sticks each with a throughhole, joined together by a connector which passes through the throughhole such that the sticks are rotatable with respect to one another and can produce different tones with a musical instrument. The sticks may be connected by spring metals instead of such a connector. Instead of the connector, a fiber member may be passed through the throughholes of the sticks, being wrapped around the sticks such that the sticks are flexibly joined together.

### BACKGROUND OF THE INVENTION

This invention relates to multiple-tipped drumming tools.

Variety is a spice in every phase of human life and endeavor. It is no exception in the field of music. Musical instruments and tools for producing different kinds of sound and tune are always in demand.

### SUMMARY OF THE INVENTION

It is therefore an object of this invention to provide drumming tools of a different kind having multiple tips such that a drum, or any percussion instrument, can be struck in different modes and produce different sound effects.

A drumming tool according to this invention may be characterized as being a multiple-tipped tool and as comprising a plural number of sticks each having a throughhole formed therethrough and a connector which passes through these throughholes such that the sticks are rotatably joined together. The sticks may be each 9 inches to 18 inches in length, and the plural number of sticks may be 2-4. The throughhole may be at a position 2 to 3 inches from one end of each of the sticks, and the connector may comprise a threaded rod and a threaded nut which engage each other.

Another drumming tool according to this invention may be characterized as comprising a plural number of sticks each having a throughhole formed therethrough and a fiber member passing through the throughholes of these sticks and being wrapped around these sticks such that these sticks are flexibly joined together. In this example, too, the sticks may be each 9 inches to 18 inches in length and the plural number of sticks may be 2-4. The throughhole may be at a position about one inch from one end of each of the sticks. The fiber member may comprise a plastic material and may have a diameter in the range of 1/32 inches to ⅛ inches, being wrapped around each of the sticks 6 to 25 times.

Still another drumming tool according to this invention may be characterized as comprising a plural number of sequentially arranged sticks each having a hole at one end and a spring metal connecting each mutually adjacent pair of these sticks.

### BRIEF DESCRIPTION OF DRAWINGS

FIG. 1 is a front view of a drumming tool embodying this invention.

FIG. 2 is a side view of the drumming tool of FIG. 1 when the sticks are opened.

FIG. 3 is a side view of the connector.

FIG. 4 is a front view of another drumming tool embodying this invention.

FIG. 5 is another front view of the drumming tool of FIG. 4 before the sticks are joined together.

FIG. 6 is a schematic view of the drumming tool of FIG. 4 showing the range of motion of each stick.

FIGS. 7 and 8 are views of portions of still other examples of the drumming tool with sticks connected by using a spring metal according to this invention.

### DETAILED DESCRIPTION OF THE INVENTION

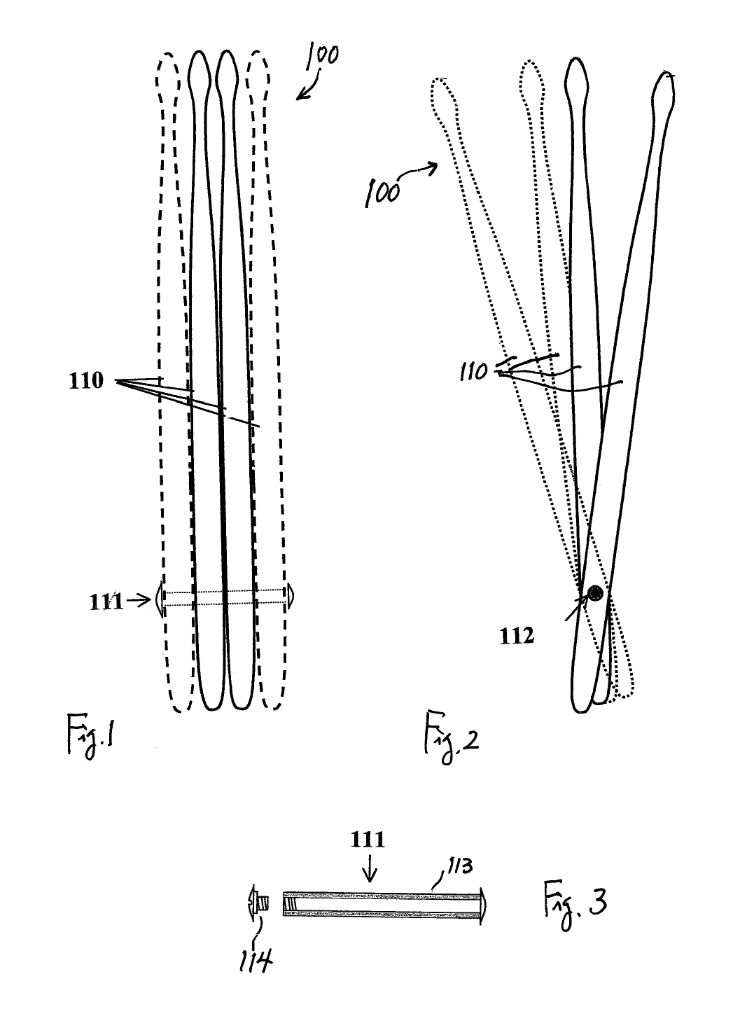

FIG. 1 shows an example of drumming tool 100 embodying this invention, characterized as having a plural number (preferably 2, 3 or 4) of sticks 110 positioned sequentially in a side-by-side relationship, adjacent to one another and joined together by means of a connector 111 passing through each of the sticks 110 such that the sticks 110 are rotatable with respect to one another and around the connector 111. Thus, the sticks 110 may be mutually parallel to each other, as shown in FIG. 1, or may be spread such that the angle between each mutually adjacent pair of them can be varied within a certain limit, as shown in FIG. 2.

There is no particular limitation on the sticks 110. They may be identical in size and shape, as in the illustrated example, but this is not intended to limit the scope of the invention. The length of each stick 110 is typically in the range of 9 inches to 18 inches. The material of the sticks 110 does not limit the scope of the invention. Any material with adequate hardness for producing conventional drum sticks may be used.

Each of the sticks 110 is provided with a throughhole 112 through which the connector 111 is passed. The position of the throughhole 112 through each of the sticks 110 is typically where the user (drummer) grasps the tool 100 for playing. This is typically 2-3 inches from one end.

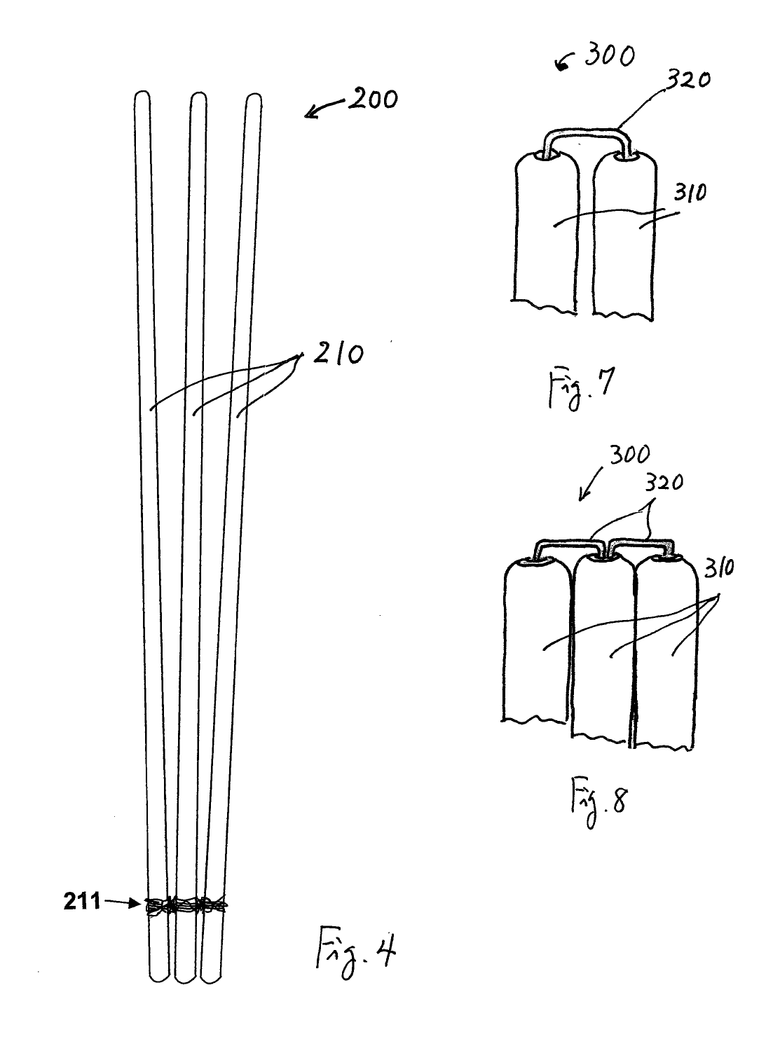

The connector 111 may comprise, as shown in FIG. 3, a hollow metal rod 113 with a threaded interior surface, or a female thread, and a removable head nut 114 having a matching male thread on its exterior. The unthreaded end of the rod 113 and the nut 114 may each have a flange to keep the sticks 110 together. Silicone washers (not shown) may be mounted on the rod at either end or between the sticks 110 if an additional ease of motion is desired for the sticks 110. Additionally, a set screw (not shown) may be inserted into the nut 114 to fix it in place on the rod 113 and to keep it from becoming loose when the tool 100 is being used.

FIG. 4 shows another example of drumming tool 200 embodying this invention, characterized as having three sticks 210 positioned sequentially in a side-by-side relationship, adjacent to one another and flexibly joined together by means of a fiber member 211 passing through and wound around each of the sticks 210 such that the sticks 210 are rotatable with respect to one another into positions such as illustrated in FIG. 5.

Although three sticks 210 are shown tied together in the illustrated example, this is not intended to limit the scope of the invention. The number of sticks 210 to be tied together in the manner shown in FIG. 4 may be varied, say, between 2 and 4. The material to be used for producing these sticks 210, their size and shape are as described above for the sticks 110 shown in FIGS. 1 and 2.

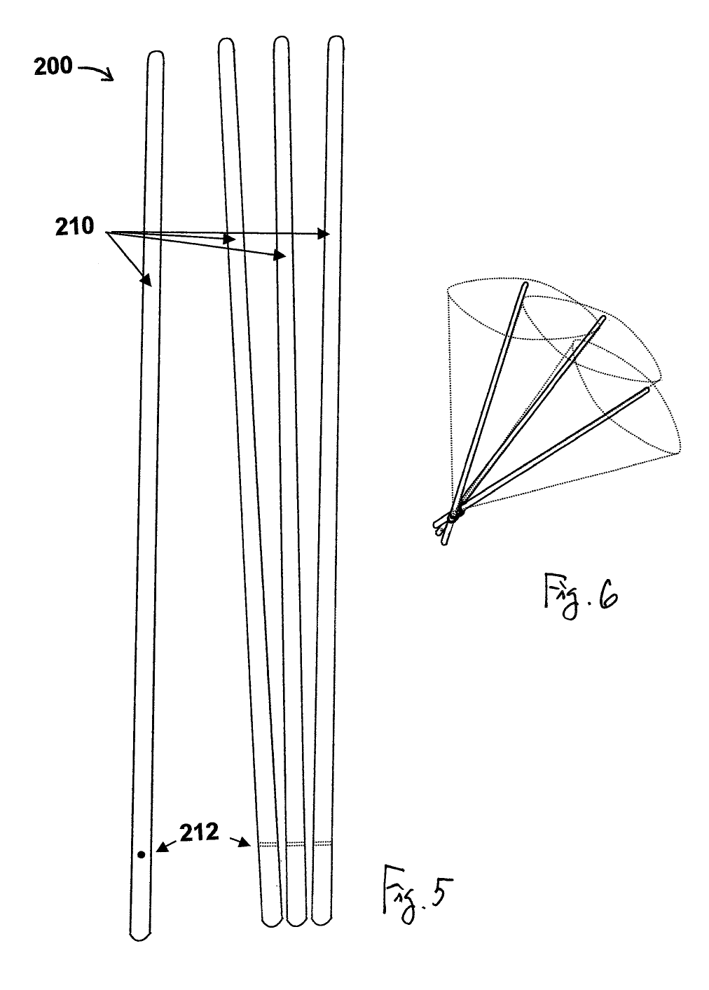

Each stick 210 is provided with a throughhole 212 at a position about 1 inch from one end. The fiber member 211 is passed through these throughholes 212, wound and wrapped around each of the sticks 210 and between the sticks 210 and tied such that a strong but elastic and flexible connection is formed so that the sticks 210 can rotate with respect to one another to vary the angles made between them, not only in one plane but in a conical trajectory as shown by dotted lines in FIG. 6. The diameter of the base of these conical trajectories may be no more than a few or several inches, limited in part by the tension and elasticity of the material of the fiber member 211 because these sticks 210 are thereby joined together. For strength, it is preferable that fiber member 211 be not only passed through the throughhole 212 of each stick 210 but also wrapped around each stick 210 6 to 25 times.

The invention does not impose any strict limitation on the physical property of the fiber material but it is preferable that its diameter be in the range of 1/32 inches to ⅛ inches and may be made of any material capable of providing sufficient strength and elasticity such as plastics, leather and cotton. Any such material which is now available or will become available in the future is to be considered usable for the purpose of this invention.

FIGS. 7 and 8 show still another way in which a plurality of sticks 310 may be connected to form a multiple-tipped drumming tool 300 of this invention. According to these examples, a spring metal 320, which is generally π-shaped with two end portions perpendicularly bent from a center portion, is used to connect each mutually adjacent pair of the sticks 310 so as to allow a limited relative motion therebetween. A small hole, say, of ⅛″ in diameter and 1½″ in depth, may be prepared at one end of each stick and filled with epoxy together with one end of the spring metal 320. FIG. 7 shows only two sticks and FIG. 8 shows only three sticks thus connected, but they are not intended to limit the scope of the invention. The total number of the sticks 310 to be thus connected sequentially may be 2-4. FIG. 7 shows the sticks 310 separated from each other, while FIG. 8 shows the mutually adjacent pairs of the sticks 310 in contact with each other. This is intended to indicate that the invention does not impose any requirement as to the mutual separation of the connected sticks 310. It also goes without saying that any hardening material may be used to seal the spring metals 320 in the end holes of the sticks 310.

In summary, the disclosure is intended to be illustrative, not limitative. Many modifications and variations are intended to be within the scope of this invention.

What is claimed is:

1. A multiple-tipped drumming tool comprising:
a plural number of sticks each having a throughhole formed therethrough;
a connector which passes through said throughhole such that said sticks are rotatably joined together.

2. The drumming tool of claim 1 wherein said sticks are each 9 inches to 18 inches in length.

3. The drumming tool of claim 1 wherein said plural number is 2-4.

4. The drumming tool of claim 1 wherein said throughhole is at a position 2 to 3 inches from one end of each of said sticks.

5. The drumming tool of claim 1 wherein said connector comprises a threaded rod and a threaded nut which engage each other.

6. A multiple-tipped drumming tool comprising:
a plural number of sticks each having a throughhole formed therethrough;
a fiber member passing through the throughholes of said sticks and being wrapped around said sticks such that said sticks are flexibly joined together.

7. The drumming tool of claim 6 wherein said sticks are each 9 inches to 18 inches in length.

8. The drumming tool of claim 6 wherein said plural number is 2-4.

9. The drumming tool of claim 6 wherein said throughhole is at a position about one inch from one end of each of said sticks.

10. The drumming tool of claim 6 wherein said fiber member comprises a plastic material.

11. The drumming tool of claim 6 wherein said fiber member has a diameter in the range of 1/32 inches to ⅛ inches.

12. The drumming tool of claim 6 wherein said fiber member is wrapped around each of said sticks 6 to 25 times.

13. A multiple-tipped drumming tool comprising:
a plural number of sticks each having a hole at one end thereof and sequentially arranged; and
a spring metal connecting each mutually adjacent pair of said sticks.

14. The drumming tool of claim 13 wherein said spring metal has two end portions perpendicularly bent from a center portion, having said bent end portions sealed in said mutually adjacent pair of said sticks.

15. The drumming tool of claim 13 wherein said plural number is 2-4.
